(19) United States
(12) Patent Application Publication
(10) Pub. No.: US 2018/0023287 A1
(43) Pub. Date: Jan. 25, 2018

(54) RADIANT REFLECTIVE AND WATER BARRIER ROOFING UNDERLAYMENT

(71) Applicants: CHING-SHYUNG CHEN, KAOHSIUNG (TW); YAO-CHUNG CHEN, TAICHUNG CITY (TW)

(72) Inventors: CHING-SHYUNG CHEN, KAOHSIUNG (TW); YAO-CHUNG CHEN, TAICHUNG CITY (TW)

(21) Appl. No.: 15/213,613

(22) Filed: Jul. 19, 2016

(51) Int. Cl. E04B 1/76; B32B 5/02; B32B 25/14; B32B 15/14; B32B 15/20; E04D 12/00; B32B 15/085

(52) U.S. Cl. CPC E04B 1/76; E04D 12/002; B32B 5/022; B32B 5/024; B32B 15/085; B32B 15/14; B32B 15/20; B32B 25/14; B32B 2262/0253; B32B 2307/744; B32B 2419/06

(57) ABSTRACT

A radiant reflective and water barrier roofing underlayment is mounted to an outer side of a radiant barrier. The radiant reflective and water barrier roofing underlayment includes an underlayment body. The underlayment body includes an inner face facing the radiant barrier and an outer face opposite to the inner face. An anti-slipping layer is mounted to the inner face of the underlayment body. A waterproof coating, an aluminum foil layer, and a non-woven layer are disposed on the outer face of the underlayment body in sequence. The aluminum foil layer has an outer face serving as a reflective face. By provision of the aluminum foil, most of the external radiant heat or the solar radiation can be blocked and reflected to reduce the heat transmitted through the roof into the building via heat radiation, thereby lowering the temperature inside the building.

### BACKGROUND OF THE INVENTION

The present invention relates to a building material and, more particularly, to a radiant reflective and water barrier roofing underlayment mounted between a radiant barrier and a roof covering material.

A water barrier roofing underlayment is mounted between a radiant barrier and roof covering material of a building for preventing water and other substances from leaking through the radiant barrier.

A conventional roofing underlayment is generally comprised of an organic paper covered by asphalt or tar with a specific density and is preserved in the form of a coiled material (building linoleum). However, the conventional tar roofing underlayment tends to become slippery when exposed to a fluid (such as rainwater or dew) or covered by dust, resulting in risks of working safety.

A synthetic roofing underlayment made of polypropylene has appeared in the market and includes a non-woven layer bonded to each of an inner side and an outer side of the roofing underlayment. Thus, during working, the friction force generated by the worker stepping on the roofing underlayment can be increased while reducing the risk of slip due to contact with water or dust.

However, although the roofing underlayment of this type can prevent water and other substances from leaking into the house via the radiant barrier while increasing the safety during working, the problem of temperature increase inside the building cannot be solved. A radiant barrier OSB has been proposed to insulate most of the heat transmitted to the building from the outside. However, such a roofing underlayment cannot avoid the penetrating type heat transfer effect resulting from the solar radiation.

Thus, a need exists for a novel roofing underlayment that mitigates and/or obviates the above disadvantages.

### BRIEF SUMMARY OF THE INVENTION

In view of the drawbacks of the prior art, the present invention provides a radiant reflective and water barrier roofing underlayment mounted to an outer side of a radiant barrier. The radiant reflective and water barrier roofing underlayment includes an underlayment body. The underlayment body includes an inner face facing the radiant barrier and an outer face opposite to the inner face. An anti-slipping layer is mounted to the inner face of the underlayment body. A waterproof coating, an aluminum foil layer, and a non-woven layer are disposed on the outer face of the underlayment body in sequence. The aluminum foil layer has an outer face serving as a reflective face.

The underlayment body can be made by weaving.

The anti-slipping layer can be made of a polyolefin elastomer.

The underlayment body, the waterproof coating layer or the non-woven layer can be made of polypropylene.

By provision of the aluminum foil, most of the external radiant heat or the solar radiation can be blocked and reflected to reduce the heat transmitted through the roof into the building via heat radiation, thereby lowering the temperature inside the building.

The present invention will become clearer in light of the following detailed description of illustrative embodiments of this invention described in connection with the drawings.

### DESCRIPTION OF THE DRAWINGS

FIG. 1 is a diagrammatic perspective view illustrating a house using a radiant reflective and water barrier roofing underlayment according to the present invention.

FIG. 2 is an enlarged, cross sectional view of a circled portion of FIG. 1.

### DETAILED DESCRIPTION OF THE INVENTION

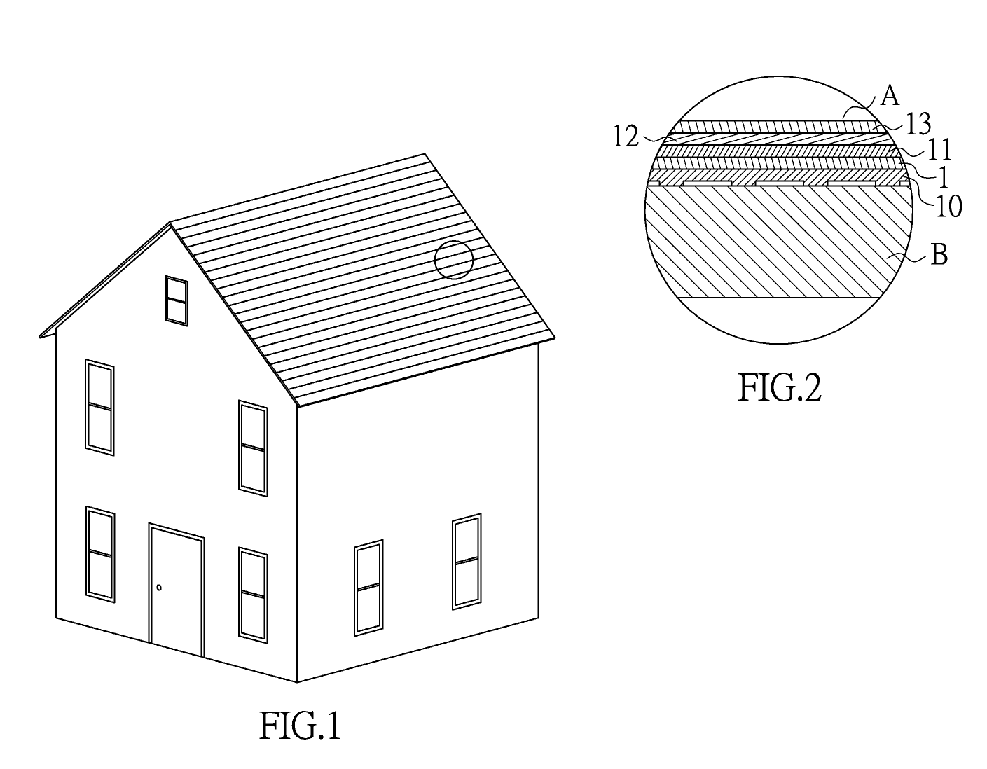

With reference to FIGS. 1 and 2, a radiant reflective and water barrier roofing underlayment A according to the present invention can be mounted to an outer side of a radiant barrier B of a building. The radiant reflective and water barrier roofing underlayment A has an inner face facing the radiant barrier B. In this embodiment, the radiant reflective and water barrier roofing underlayment A includes an underlayment body 1 preferably made of polypropylene (PP) by weaving, providing the underlayment body 1 with a better anti-pulling strength to resist pulling from various external forces or tearing from strong wind.

The underlayment body 1 includes an inner face facing the radiant barrier B and an outer face opposite to the inner face. An anti-slipping layer 10 is mounted to the inner face of the underlayment body 1. The anti-slipping layer 10 is preferably made of a polyolefin elastomer (POE) to provide a larger friction force, preventing slipping between the radiant reflective and water barrier roofing underlayment A and the radiant barrier B. A waterproof coating 11, an aluminum foil layer 12, and a non-woven layer 13 are disposed on the outer face of the underlayment body 1 in sequence. The aluminum foil layer 12 has an outer face serving as a reflective face.

The waterproof coating 11 is applied to the PP layer on the outer face of the underlayment body 1 to fill the gaps in the underlayment body 1 resulting from weaving, thereby improving the waterproof effect of the radiant reflective and water barrier roofing underlayment A of the present invention.

The aluminum foil layer 12 is mounted to the outer face of the underlayment body 1. Furthermore, the outer face of the aluminum foil layer 12 is a reflective face (which is smooth and can reflect light easily). By provision of the aluminum foil 12, most of the external radiant heat or the solar radiation can be blocked and reflected to reduce the heat transmitted through the roof into the building via heat radiation, thereby lowering the temperature inside the building.

The non-woven layer 13 is bonded to the outer face of the aluminum foil layer 12 to form a rugged face with a larger friction on the outer face of the aluminum foil layer 12. Thus, an anti-slipping effect can be obtained while a worker is walking on the radiant reflective and water barrier roofing underlayment A, increasing the working safety.

Although specific embodiments have been illustrated and described, numerous modifications and variations are still possible without departing from the scope of the invention. The scope of the invention is limited by the accompanying claims.

What is claimed is:

1. A radiant reflective and water barrier roofing underlayment adapted to be mounted to an outer side of a radiant barrier, with the radiant reflective and water barrier roofing underlayment including an underlayment body, with the underlayment body including an inner face facing the radiant barrier and an outer face opposite to the inner face, with an anti-slipping layer mounted to the inner face of the underlayment body, with a waterproof coating, an aluminum foil layer, and a non-woven layer disposed on the outer face of the underlayment body in sequence, and with the aluminum foil layer having an outer face serving as a reflective face.

2. The radiant reflective and water barrier roofing underlayment as claimed in claim 1, wherein the underlayment body is made by weaving.

3. The radiant reflective and water barrier roofing underlayment as claimed in claim 1, wherein the anti-slipping layer is made of a polyolefin elastomer.

4. The radiant reflective and water barrier roofing underlayment as claimed in claim 3, wherein the underlayment body, the waterproof coating layer or the non-woven layer is made of polypropylene.
